(19) United States
(12) Patent Application Publication
(10) Pub. No.: US 2002/0018473 A1
(43) Pub. Date: Feb. 14, 2002

(54) SYSTEM AND METHOD FOR CHARACTERIZING BURST INFORMATION

(76) Inventors: SUZANNE HASSELL, CLEARWATER, FL (US); ROBERT STEINBERGER, LARGO, FL (US)

Correspondence Address: SCOTT A HORSTEMEYER, THOMAS KAYDEN HORSTEMEYER & RISLEY, SUITE 1500, 100 GALLERIA PARKWAY N W, ATLANTA, GA, 303395948

(21) Appl. No.: 09/118,106

(22) Filed: Jul. 17, 1998

Related U.S. Application Data
(60) Provisional application No. 60/071,756, filed on Jan. 16, 1998.

(51) Int. Cl. H04L 12/28

(52) U.S. Cl. 370/395.1; 370/474

(57) ABSTRACT

A system and method for characterizing burst data in a communication network detects the occurrence of burst information and categorizes the burst information into at least one category based upon either bits or frames. Because one second time intervals may contain multiple categories of burst information, the analysis of which may overwhelm a network management system, the burst categorization logic of the present invention allows the capture and analysis of multiple burst categories in a single time interval over a long period of time, thereby allowing the analysis of a large amount of information without overwhelming a network management system with data.

### CROSS REFERENCE TO RELATED APPLICATION

This document claims priority to and the benefit of the filing date of copending and commonly assigned provisional application entitled METHOD FOR CHARACTERIZING BURST INFORMATION IN A FRAME RELAY NETWORK, assigned Ser. No. 60/071,756, filed Jan. 16, 1998, and hereby incorporated by reference.

### BACKGROUND OF THE INVENTION

1. Field of the Invention

The present invention relates generally to data communications, and, more particularly, to a system and method for characterizing burst traffic information in a communication system.

2. Related Art

Historically, in the field of data communications, a modem, a data service unit (DSU), or a channel service unit (CSU) has used to convey information from one location to another. Digital technology now enables modems or other communication devices, such as frame relay data service units (DSU's), frame relay access units (FRAU's), and asynchronous transfer mode (ATM) communication devices to communicate large amounts of data. This communication scheme generally adheres to a model, known as the Open Systems Interconnect (OSI) Seven-Layer model. This model specifies the parameters and conditions under which information is formatted and transferred over a given communications network. A general background of the OSI seven-layer model follows.

In 1978, a framework of international standards for computer network architecture known as “OSI” (Open Systems Interconnect) was developed. The OSI reference model of network architecture consists of seven layers. From the lowest to the highest, the layers are: (1) the physical layer; (2) the datalink layer; (3) the network layer; (4) the transport layer; (5) the session layer; (6) the presentation layer; and (7) the application layer. Each layer uses the layer below it to provide a service to the layer above it. The lower layers are implemented by lower level protocols which define the electrical and physical standards, perform the byte ordering of the data, and govern the transmission, and error detection and correction of the bit stream. The higher layers are implemented by higher level protocols which deal with, inter alia, data formatting, terminal-to-computer dialogue, character sets, and sequencing of messages.

Layer 1, the physical layer, controls the direct host-to-host communication between the hardware of the end users' data terminal equipment (e.g., a modem connected to a PC).

Layer 2, the datalink layer, generally fragments the data to prepare it to be sent on the physical layer, receives acknowledgment frames, performs error checking, and re-transmits frames which have been incorrectly received.

Layer 3, the network layer, generally controls the routing of packets of data from the sender to the receiver via the datalink layer, and it is used by the transport layer. An example of the network layer is the Internet Protocol (IP), which is the network layer for the TCP/IP protocol widely used on Ethernet networks. In contrast to the OSI seven-layer architecture, TCP/IP (Transmission Control Protocol over Internet Protocol) is a five-layer architecture which generally consists of the network layer and the transport layer protocols.

Layer 4, the transport layer, determines how the network layer should be used to provide a point-to-point, virtual, error-free connection so that the end point devices send and receive uncorrupted messages in the correct order. This layer establishes and dissolves connections between hosts. It is used by the session layer. TCP is an example of the transport layer.

Layer 5, the session layer, uses the transport layer and is used by the presentation layer. The session layer establishes a connection between processes on different hosts. It handles the creation of sessions between hosts as well as security issues.

Layer 6, the presentation layer, attempts to minimize the noticeability of differences between hosts and performs functions such as text compression, and format and code conversion.

Layer 7, the application layer, is used by the presentation layer to provide the user with a localized representation of data which is independent of the format used on the network. The application layer is concerned with the user's view of the network and generally deals with resource allocation, network transparency and problem partitioning.

The communications networks that operate within the OSI seven-layer model include a number of paths or links that are interconnected to route voice, video, and/or digital data (hereinafter, collectively referred to as “data”) traffic from one location of the network to another. At each location, an interconnect node couples a plurality of source nodes and destination nodes to the network. In some cases, the sources and destinations are incorporated in a private line network that may include a series of offices connected together by leased-lines with switching facilities and transmission equipment owned and operated by the carrier or service provider and leased to the user. This type of network is conventionally referred to as a circuit-switching network. Accordingly, a source node of one office at one location of the network may transmit data to a destination node of a second office located at another location of the network through their respective switching facilities.

At any given location, a large number of source nodes may desire to communicate through their respective switching facilities, or interconnect node, to destination nodes at various other locations of the network The data traffic from the various source nodes is first multiplexed through the source switching facility, and then demultiplexed at the destination switching facility and finally delivered to the proper destination node. A variety of techniques for efficiently multiplexing data from multiple source nodes onto a single circuit of the network are presently employed in private line networks. For instance, time division multiplexing (TDM) affords each source node full access to the allotted bandwidth of the circuit for a small amount of time. The circuit is divided into defined time segments, with each segment corresponding to a specific source node, to provide for the transfer of data from those source nodes, when called upon, through the network.

Other data communications systems, in contrast, have not been as successful with employing multiplexing techniques to further enhance network efficiency. In particular, frame-relay networks offer fewer alternatives than their circuit-switching network counterparts. Frame-relay networks are one implementation of a packet-switching network. A packet-switching network, as opposed to circuit-switching network, allows multiple users to share data network facilities and bandwidth, rather than providing a specific amount of dedicated bandwidth to each user, as in TDM. Instead, packet switches divide bandwidth into connectionless, virtual circuits. Virtual circuits can be permanent virtual circuits (PVC's) or switched virtual circuits (SVC's). As is known, virtual circuit bandwidth is consumed only when data is actually transmitted. Otherwise, the bandwidth is not used. In this way, packet-switching networks essentially mirror the operation of a statistical multiplexer (whereby multiple logical users share a single network access circuit). Frame relay generally operates within layer 2 (the data link layer) of the OSI model, and is an improvement over previous packet switching techniques, such as X.25, in that frame relay requires significantly less overhead.

In all communication networks, network performance measurements are vital to the proper operation of any given network. For example, the quality of service committed to and provided by a network provider is based upon network conditions and also on conditions for which the network user is responsible. Typically, network providers will provision services to an end user by specifying a committed information rate (CIR). The CIR is the data communication rate that the provider guarantees the user. The CIR is typically some fraction of the total available line rate of the particular service being provisioned. For example, in a frame relay network, the line rate may be 1536000 bits/second (T1 rate including 24 64-kilobit (KB) channels for a total of 1.544 megabits/second (MB/s) including 8 KB signaling), while the CIR may be 48000 bytes/second (384000 bits/second (b/s)). That is, for this example, the network provider may guarantee a communication rate of 384000 b/s, while the total available line rate may be 1536000 b/s.

Some of the above described communication environments are used to transmit “bursty” data traffic. Burstiness in this context can best be described as data communication traffic that is sporadic in nature, with bursts of traffic occurring at frequent, but irregular, time intervals. When transmitting this bursty traffic, information on the size and extent of traffic bursts above the CIR is extremely useful in order to determine whether and how often a user exceeds the CIR and the extent of the burstiness of the traffic.

Typically, burst parameters are measured over 1 second time intervals, which will be denoted by T_{C}. The T_{C} interval is of fixed duration, but does not necessarily occur at fixed intervals. The receipt of data triggers a timer to begin timing the T_{c} interval. In order to collect burst characteristic information, existing techniques keep burst data in 1 second interval categories, or buckets. If burst categories are used based upon seconds (i.e., % of seconds that a burst was recorded at 200% CIR, for example) the resolution would be insufficient to discriminate between burst categories. This is so because the concept of “bursty seconds” does not exist in packet switching. In packet switching bursts are measured in bits (or bytes) and entire frames are marked discard eligible (DE) or discarded depending upon where the bits within the frame fall in relation to the CIR. In one second, the entire spectrum of burst categories could be encompassed. Merely choosing a single category per second would cause the bursting to appear to be worse (if worst category were chosen) or best (if lowest burst category were chosen). This manner of categorizing burst traffic is highly inaccurate.

Another problem with current systems for categorizing burst data traffic is that they require a large amount of system resource in the form of system memory. Furthermore, current systems require that excessive amounts of information be transmitted to a network management system (NMS) resulting in instances where the NMS cannot process the information received before receiving another updated set of information. This is caused by some systems that provide only one (1) second category buckets having the number of bits sent for each second supplied to the NMS for burst analysis. This small interval causes excessive data to be generated, which in turn must be sent to the NMS and analyzed. This results in the NMS being unable to keep pace with the data collection.

Therefore, it would be desirable to provide a system and method that will characterize burst information based upon usage criteria that can be completely categorized over a given time interval and without overwhelming the ability of the NMS to process and present the information to a user.

### SUMMARY OF THE INVENTION

The present invention provides an improvement to a communication environment by enabling the collection and categorization of burst data traffic in a communication network and providing the information in a manner that enables the data to be economically analyzed.

This task is accomplished by providing a system for characterizing burst communication traffic. The invention includes a detector for detecting the occurrence of burst information, characterizing logic for characterizing the burst information into at least one category, and a counter for counting each occurrence of the burst information in each category.

The present invention can also be conceptualized as providing a method for characterizing burst information communication traffic, comprising the following steps. First, the occurrence of burst information is detected. Next, the burst information is characterized as belonging in at least one category. Then, each occurrence of the burst information in each category is counted with the counter being incremented for each category of detected bursts of data.

The invention has numerous advantages, a few of which are delineated hereafter, as merely examples.

An advantage of the present invention is that it enables the capture and categorization of burst data information over a time period sufficient to allow useful analysis.

Another advantage of the present invention is that it allows burst data information to be collected and categorized in a manner that optimizes the resources available to a network management system (NMS).

Another advantage of the invention is that because bits and frames are categorized, it allow precise correlation with frame relay switch information and comparison with data delivery success rate, which is presented in bits or frames.

Another advantage of the invention is that it reduces the amount of memory required in the communication device.

Another advantage of the invention is that it reduces the amount of polling required by a network management system.

Another advantage of the invention is that it improves the performance of a network management system by allowing the processing to occur in a communications device.

Another advantage of the present invention is that it is simple in design, reliable in operation, and its design lends itself to economical mass production in communication devices.

Other features and advantages of the present invention will become apparent to one with skill in the art upon examination of the following drawings and detailed description. It is intended that all such additional features and advantages be included herein within the scope of the present invention, as defined in the appended claims.

### BRIEF DESCRIPTION OF THE DRAWINGS

The present invention, as defined in the claims, can be better understood with reference to the following drawings. The components within the drawings are not necessarily to scale relative to each other, emphasis instead being placed on clearly illustrating the principles of the present invention.

FIG. I is a block diagram of a network model illustrating the framework within which the present invention operates;

FIG. 2 is a schematic view illustrating a communication device in which the burst categorization logic resides;

FIG. 3 is a schematic view illustrating the network access module of FIG. 2 including the burst categorization logic of the present invention;

FIG. 4 is a graphical representation illustrating the operation of the burst categorization logic of FIGS. 2 and 3;

FIG. 5 is a graphical representation of the information supplied by the burst categorization logic of FIGS. 2 and 3; and

FIG. 6 is a flow chart illustrating the architecture, functionality, and operation of the burst categorization logic of FIGS. 2 and 3.

### DETAILED DESCRIPTION OF THE PREFERRED EMBODIMENT

The burst categorization logic of the present invention can be implemented in software, hardware, or a combination thereof. In the preferred embodiment, the burst categorization logic is implemented in software that is stored in a memory and that is executed by a suitable microprocessor (uP) situated in a communications device. However, the burst categorization program, which comprises an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Furthermore, the preferred embodiment of the burst categorization logic is illustrated in the context of a frame relay communications network; however, the concepts and principles of the burst categorization logic are equally applicable to other communication techniques in which the data communicated may be considered “bursty” in nature.

FIG. 1 shows a communication topography 11 in which communications devices containing the burst categorization logic operate. In general the communications environment includes a plurality of user devices 4a, 4b, and 4c, each connected to a plurality of communication devices 12a 12b, and 12c over connections 6a, 6b, and 6c respectively. Communication devices 12a, 12b, and 12c can be any communication device such as a modem, or a frame relay access unit (FRAU) that communicates bursty data traffic over communication network 16 in a conventional manner. Data that is nonperiodic, or transmitted at irregular intervals, is considered bursty in nature. Typically, bursty data is transmitted in packetized form by a packet-switching network, which lends itself to the transmission of bursty data. Communication network 16 includes components that are known in the art and illustratively connect to communication devices 12a, 12b, and 12c over connections 21, 22, and 23 respectively. Connections 21, 22, and 23 are physical links and can be, for example, T1/E1 service or any analog or digital data service (DDS).

Communication network 16 can be a frame relay communication network and is typically characterized by a mesh network of links (not shown) interconnecting a matrix of intermediate nodes (not shown) through frame relay switches 17 and 18. For simplicity only two frame relay switches are illustrated herein. However, communication network 16 will typically contain many switching devices. The links are identified by data link connection identifiers (DLCI's), which are used to identify the logical connection over which the subject data is transported. The use of DLCI's allows multiple logical connections to be multiplexed over the same physical channel. For example, communication device 12a may communicate with communication device 12b over a predefined communication path or link within network 16. This communication path will generally be defined by a number intermediate nodes. The communication link that interconnects communication device 12a and communication device 12b may be completely separate and distinct from that which interconnects communication device 12a and 12c. Alternatively, a segment of the two above-described communication links may be shared. Whether the links are separate or shared is a function of a number of factors and generally is determined by the service provider.

Within network 16 the communication path between communication device 12a and communication device 12b, for example, will be the same in both directions. That is, data transmitted from communication device 12a to communication device 12b will traverse the same path (i.e., interconnecting, intermediate nodes) as will data transmitted from communication device 12b to communication device 12a. This path of intermediate nodes is defined by DLCI's, and is commonly referred to as a permanent virtual circuit (PVC). This name derives from the fact that the circuit is permanent in that it does not change from transmission to transmission. It is, however, virtual in the sense that a unitary physical connection (such as a dedicated leased line) is not established and maintained between the two end points. If for some reason or another the service provider decides to change the interconnecting path (i.e., reconfigure or redefine the intermediate nodes), the service provider will communicate this changed communication path to the users and a new set of DLCI's will be used in order to properly route the data from end point to end point. DLCI's are assigned to and define all the points in a network through which data passes. For simplicity the burst categorization logic 100 is described herein as applied to permanent virtual circuits (PVC's); however, the burst categorization logic 100 is equally applicable to communication networks employing switched virtual circuits (SVC's). PVC's 19a, 19b, and 19c of FIG. 1 illustrate the concept of multiple communication paths within network 16. Bursty data traversing network 16 is typically monitored by the FRAU's 12a, 12b, and 12c and by frame relay switches 17 and 18 in order to determine the characteristics and the flow of data traversing the network and is typically measured in bits (or bytes). Data is typically characterized by the size and extent of bursts occurring above a committed information rate (CIR). A CIR is the data rate at which a service provider is meeting a promised data rate commitment to an end user. The CIR is typically below the possible “line rate”, which is the maximum rate at which the particular communication channel may operate. However, in the case of bursty communication data, the CIR of a particular communication channel is frequently exceeded. The burst categorization logic of the present invention creates “buckets”, or categories into which bursts (of bits, or bytes) of data are categorized for analysis and display by network management system (NMS) 13 and will be explained in detail hereafter.

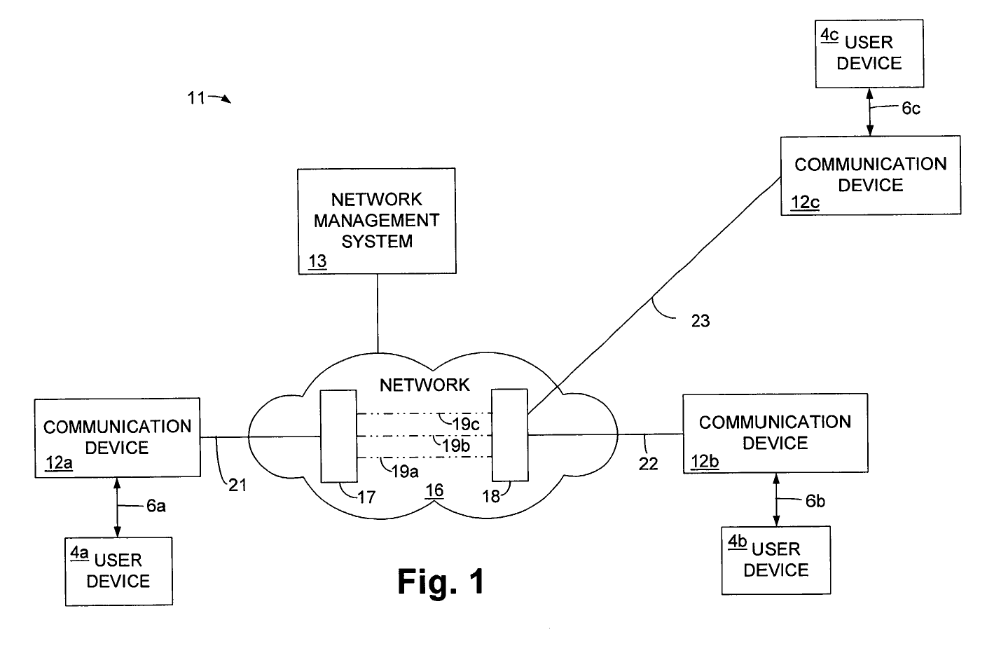

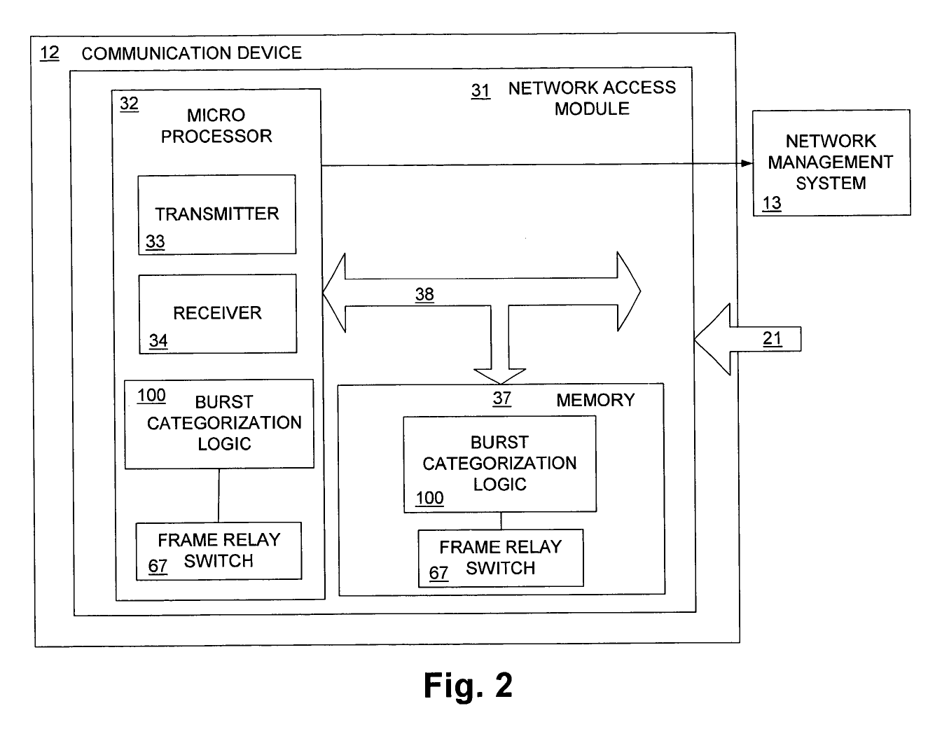

FIG. 2 shows a block diagram of a communication device 12 in which the burst categorization logic 100 of the present invention resides. The logic of the present invention resides within each communication device 12. Communication device 12 is typically the access unit that connects user equipment to a communication network and is illustratively a frame relay access unit (FRAU).

Communication device 12 contains a number of conventional components that are well known in the art of data communications. Network access module (NAM) 31 includes microprocessor (uP) 32, which is configured to control the operation of the communication device's transmitter 33 and receiver 34 and which is configured to couple to memory 37 over bus 38. Access to communication channel 21 is provided by NAM 31. Omitted from FIG. 2 for simplicity are a number of conventional components of communication device 12 that are not necessary to explain the operation of the burst categorization logic and known to those skilled in the art.

Communication channel 21 is typically the physical wire that extends from a communication network and connects to NAM 31 to provide access into a communication network. However, communication channel 21 can be any medium for connecting the communication device 12 to a communication network.

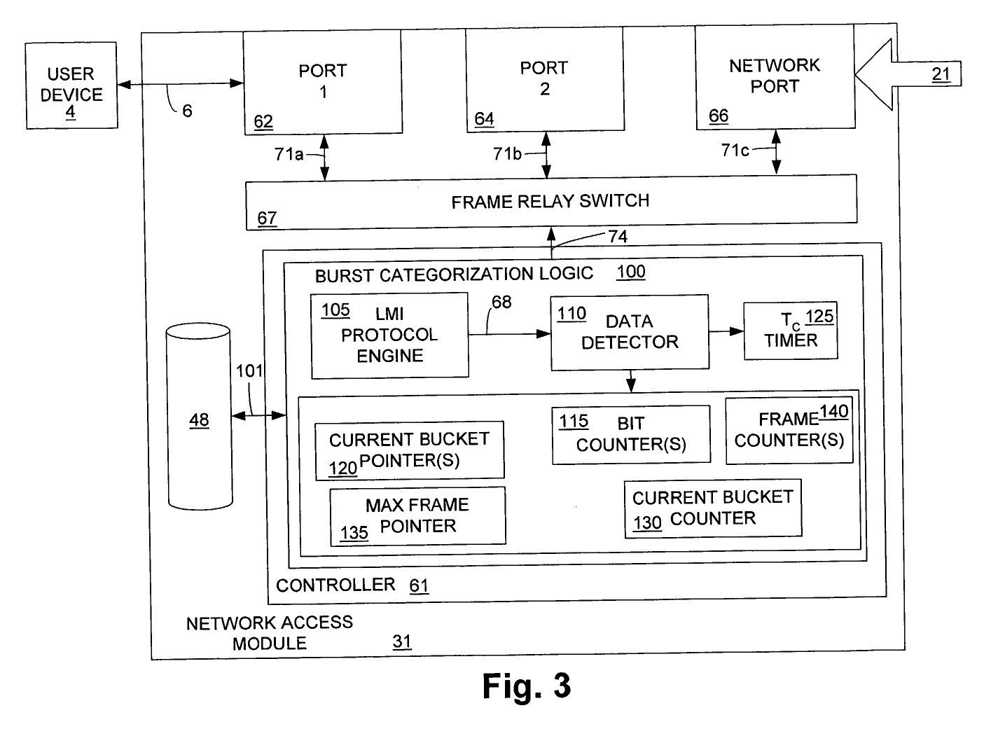

Contained within memory 37 is the burst categorization logic 100 of the present invention. Burst categorization logic 100 is configured to enable and drive uP 32 to allow the detection and categorization of burst data transmitted by communication device 12 over network 16. Because burst categorization logic 100 is an algorithm that configures and drives uP 32, it is depicted as residing within both memory 37 and uP 32. Burst categorization logic 100 detects and categorizes burst data transmissions and causes bit counter 115 (FIG. 3) to increment each time a burst is detected in each category and will be described in detail hereafter. Similarly, frame relay switch 67 resides in memory 37 and executes in uP 32.

Turning now to FIG. 3, shown is the network access module (NAM) of FIG. 2 including the burst categorization logic 100 of the present invention.

Network access module (NAM) 31 illustratively includes communication port 62 (port 1), communication port 64 (port 2), and network port 66. NAM 31 may contain fewer or additional ports and ports 62, 64 and the network port 66 are shown for illustrative purposes only. Ports 62, 64, and the network port 66 each connect to frame relay switch 67 through connections 71a, 71b, and 71c respectively. Illustratively, network port 66 connects to communication channel 21 and port 62 (port 1) connects to user device 4.

The operation of frame relay switch 67 will be discussed hereafter. Frame relay switch 67 receives configuration updates through connection 74 from controller 61, which contains the burst categorization logic 100 of the present invention.

Controller 61 contains the burst categorization logic 100 that enables FRAU 12 to detect the presence of burst communication data on the local management interface and categorize that information using sliding window T_{c} based upon bits or frames detected.

Burst categorization logic 100 includes data detector 110, which detects the presence of burst data transmission on the local management interface (LMI) over connection 68 from LMI protocol engine 105. Once a burst is detected by data detector 110, burst categorization logic 100 sends a message on connection 101 to burst categorization database 48 containing information pertaining to the burst message received. The burst message received is categorized depending upon the amount of data received in the measured burst and stored in burst categorization database 48. Once the burst is categorized, the appropriate counter will be incremented for that category. For example, the appropriate bit counter 115 will be incremented for that category where burst data is detected. It should also be noted that while depicted as residing within NAM 31, the LMI protocol engine 105 is part of the frame relay area.

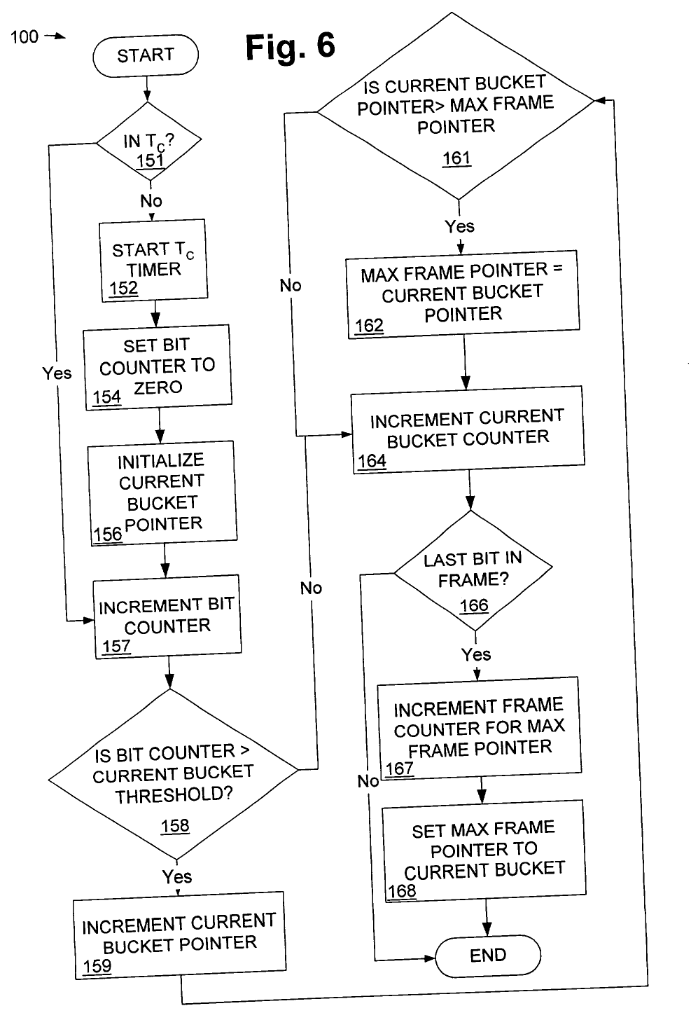

Also included in burst categorization logic 100 are T_{C} timer 125, current bucket counter 130, frame counter 140, max frame pointer 135 and current bucket pointer 120, the operation of which will be described in detail with reference to FIG. 6. Furthermore, while illustrated as single elements, bit counter 115, current bucket pointer 120, and frame counter 140 each comprise a plurality of counters, one for each category of detected burst data.

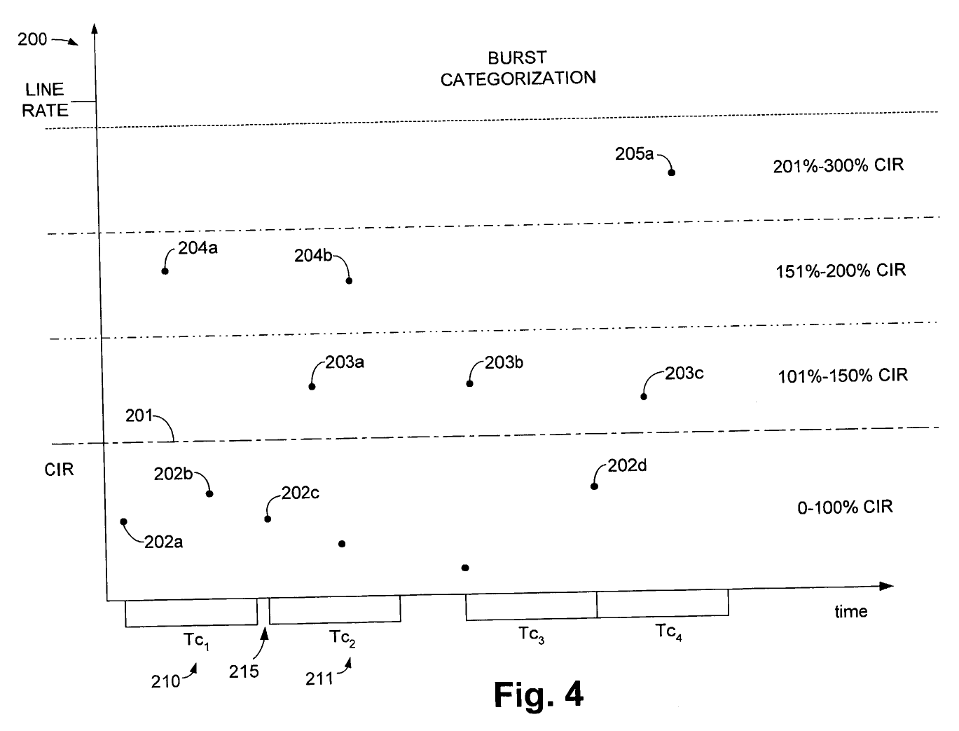

FIG. 4 shows a graphical representation 200 illustrating the operation of the burst categorization logic 100 of FIG. 2. Depicted on the horizontal axis of graph 200 is time in intervals T_{C,} which may be separated in time if no data is sent. The beginning of a new T_{C} interval is synchronized to the detection of data by data detector 110 of FIG. 3. Shown on the vertical axis of graph 200 are the burst characterization categories, or buckets, of the present invention as a function of data rate. T_{C} (the committed rate measurement interval) is the time interval during which a user is allowed to send B_{C} (committed amount of data) or B_{C} (committed amount of data) plus Be (excess amount of data). T_{C} is computed from the service parameters of CIR and B_{C,} as T_{C} =B_{C}/CIR, where CIR is the committed information rate and B_{C} is the committed amount of data. T_{C} is not a periodic measurement interval, but rather a sliding window that is triggered by the receipt of user data. Once the T_{C} interval (i.e., 210, 211, etc. of FIG. 4) has been initiated, it continues until it completes its computed duration. For example, T_{C1,} 210 is initiated upon receipt of burst data represented by point 202a. Once T_{C1} elapses another timing interval will only begin upon receipt of another burst transmission. This concept is illustrated by blank space 215 between timing interval T_{C1} and T_{C2.} Timing interval T_{C2} is not begun until the receipt of, in this example, data represented by point 202c.

Line 201 illustrates the committed information rate (CIR), which is the rate that the service provider typically guarantees to an end user. The points referenced by numerals 202, 203, 204 and 205 illustratively indicate detected bursts of data traffic detected at 0%-100% CIR, 101%-151% CIR, 151%-200% CIR, and 201%-300% CIR respectively. As can be seen, the burst categorization logic 100 detects each burst of data and categorizes each burst according to its data rate.

To illustrate the concept of burst data categories consider the following. The region of data rate between zero (0) and the CIR can be considered one category, or bucket. The region of data rate between, for example, the CIR and 150% CIR can be considered another category, or bucket. Similarly, the region between 151% CIR and 200% CIR may be another burst category, and the region of 201% CIR to 300% CIR may yet be another category. These categories are for illustrative purposes only and may be of varying scale. For example, the categories may alternatively be classified as a percentage of line rate, or the categories may be classified based upon raw data numbers.

The burst categorization logic 100 of the present invention allows the categorization of burst data in a plurality of categories in any given time interval. For example, in time interval T_{C1} 210 (typically, one (1) second) there may be transmitted multiple bursts of data illustrated by points 202a and 202b in one category, and point 204a in another category. The burst data represented by points 202a and 202b were classified as being somewhat less than the CIR while the burst data represented by point 204a is classified as being in the range of 151% CIR to 200% CIR. The burst categorization logic 100 of the present invention discriminates and tracks bursts of data at different rate categories occurring in a given time interval. Each time a new time interval is begun (e.g., the T_{C2} interval denoted by 211), the data rate is reset to zero and as the data rate crosses a threshold (e.g., as a % of CIR, % of line rate, or a fixed number) the number of bits (or bytes) above the threshold is again counted in the category in which it occurs

Each time that a burst occurs in a given category, bit counter 115 (FIG. 3) increments thus keeping a count of the number of occurrences of burst data in each category. Each time that a burst is detected, burst categorization logic 100 updates burst category database 48 over connection 101.

In addition, the burst categorization logic 100 allows the storage intervals to be longer than the typical 15 minute storage interval, while the burst information is still captured satisfactorily, with appropriate granularity and resolution.

Furthermore, because the T_{C} timer is switched according to the receipt of data, better correlation with frame relay switch statistics can be achieved.

For example, the burst information is still captured, however, there is less performance impact on the network management system (NMS), which can read fewer buckets in which the bursts are already categorized.

The aforementioned bursts of data (i.e., 202, 203, etc.) could be identified as bits for higher resolution, or could be identified as bytes to prevent the counters from overflowing. Additionally, a frame count can be kept for each category such that the worst bit category for that frame would cause a frame count to be incremented. This may be desirable because service providers keep information based upon frame counts (as do frame relay switches). Keeping the frame counts allows the correlation of data with the switches inside a network for troubleshooting.

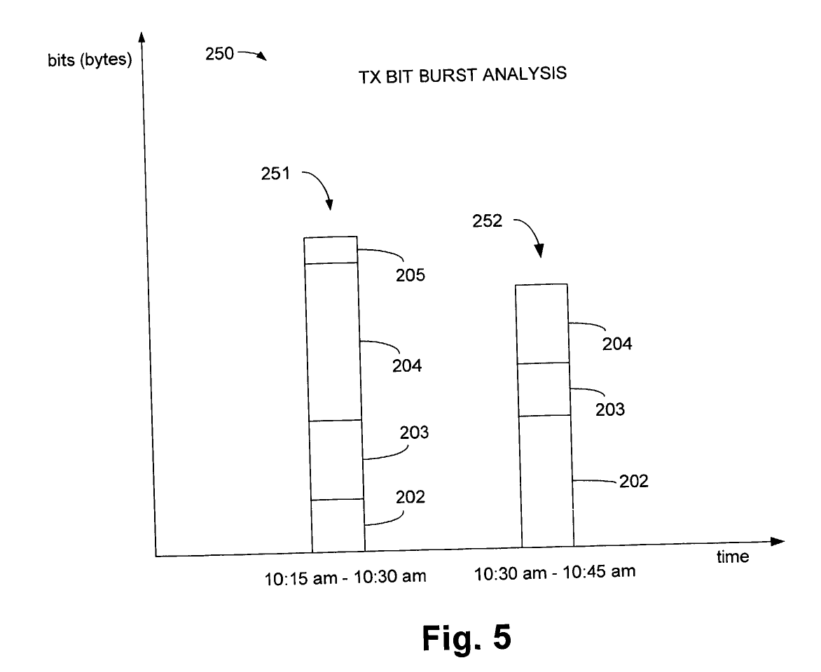

FIG. 5 shows a graphical representation of the information supplied by the burst categorization logic of FIGS. 2 and 3 as presented to a user, or a network operator. The horizontal axis of graph 250 indicates time of day and the vertical axis of graph 250 indicates burst data in bits (or bytes). The stack bars in graph 250 illustrate one manner in which the information gathered by the burst categorization logic 100 may be presented on a graphical display device. Stack bar 251 includes bit (or byte) burst data gathered during the time intervals described in FIG. 3, however in FIG. 4 the data is arranged to reflect the quantity of bursts detected in each category. For example, all the information collected that occurred below the CIR is depicted as portion 202 of stack 251. Similarly, the portion of information collected that occurred between 101% CIR and 150% CIR is depicted as portion 203 of stack 251, the portion of information collected that occurred between 151% CIR and 200% CIR is depicted as portion 204 of stack 251, and the portion of information that occurred between 201% CIR to 300% CIR is depicted as portion 205 of stack 251.

Stack 251 illustratively represents all the burst data collected during the 15 minute period between 10:15 am and 10:30 am on a particular day. Similarly, stack 252 represents all the burst data collected between 10:30 am and 10:45 am. Stack 252 illustrates the condition where no burst data was detected as occurring above 200% of the CIR as noted by the absence of a portion 205. These times are shown for illustration purposes only. Any time period may be analyzed and presented using the concepts illustrated herein.

FIG. 6 is a flow chart 100 illustrating the architecture, functionality, and operation of the burst categorization logic, which in the preferred embodiment is software or firmware, of FIGS. 2 and 3.

In decision block 151 it is determined whether a received burst of information is contained within the timer period of a currently operating T_{C} timer. If T_{C} timer 125 is currently timing, then the received information causes bit counter 115 to increment. If the burst data is received while T_{C} timer 125 is currently idle, then in block 152 T_{C} timer 125 is started.

In block 154 bit counter 115 is set to zero, and in block 156 current bucket pointer 120 is initialized. In block 157 bit counter 115 is incremented.

In decision block 158 it is determined whether the value of bit counter 115 is greater than the value of the current bucket threshold. If the current bucket threshold exceeds the value of the bit counter 115, then current bucket counter 130 is incremented. If the value of the bit counter 115 exceeds the current bucket threshold, then in block 159 the current bucket pointer 120 is incremented.

In decision block 161 it is determined whether the value of the current bucket pointer 120 exceeds the value of the max frame pointer 135. If the current bucket pointer exceeds the max frame pointer, then in block 162 the max frame pointer 135 equals the current bucket pointer 120. If the value of the current bucket pointer 120 does not exceed the value of the max frame pointer 135, then in block 164 the current bucket counter 130 is incremented.

In decision block 166 it is determined whether the bit is the last bit in the frame. If the current bit was the last bit in the frame, then in block 167 frame counter 140 is incremented for the max frame pointer 135. Finally, in block 168, the max frame pointer 135 is set to the current bucket. If the bit was not the last bit in the frame, then the process is ended.

It will be obvious to those skilled in the art that many modifications and variations may be made to the preferred embodiments of the present invention, as set forth above, without departing substantially from the principles of the present invention. For example, the system and method for characterizing burst information can be implemented in any communication environment in which bursty data traffic is communicated. All such modifications and variations are intended to be included herein within the scope of the present invention, as defined in the claims that follow.

Therefore, the following is claimed:

1. A system for characterizing burst communication traffic, comprising:
detecting means for detecting the occurrence of burst information;
characterizing means for characterizing said burst information into at least one category; and
counting means for counting each occurrence of said burst information in each said category.

2. The system of claim 1, wherein each occurrence of said burst information is categorized by bits.

3. The system of claim 1, wherein each occurrence of said burst information is categorized by frames.

4. The system of claim 1, wherein said burst information is frame relay data.

5. The system of claim 1, wherein said burst information is asynchronous transfer mode (ATM) data.

6. The system of claim 1, wherein said characterizing means further includes:
means for detecting a quantity of said burst information; and
creating at least one category into which said burst information is placed.

7. The system of claim 1, wherein said at least one category represents a portion of a committed information rate (CIR).

8. A method for characterizing burst information communication traffic, comprising the steps of:
detecting the occurrence of burst information;
characterizing said burst information into at least one category; and
counting each occurrence of said burst information in each said category.

9. The method of claim 8, wherein said burst information is categorized by bits.

10. The method of claim 8, wherein said burst information is categorized by frames.

11. The method of claim 8, wherein said burst information is frame relay data.

12. The method of claim 8, wherein said burst information is asynchronous transfer mode (ATM) data.

13. The method of claim 8, wherein said characterizing step further includes the steps of:
detecting a quantity of said burst information; and
creating at least one category into which said burst information is placed.

14. The method of claim 8, wherein said at least one category represents a portion of a committed information rate (CIR).

15. A computer readable medium having a program for characterizing burst information communication traffic, the medium comprising:
means for detecting the occurrence of burst information;
means for characterizing said burst information into at least one category;
means for counting each occurrence of said burst information in each said category.

16. The medium of claim 15, wherein said burst information is categorized by bits.

17. The medium of claim 15, wherein said burst information is categorized by frames.

18. The medium of claim 15, wherein said burst information is frame relay data.

19. The medium of claim 15, wherein said burst information is asynchronous transfer mode (ATM) data.

20. The medium of claim 15, wherein said characterizing means further includes:
means for detecting a quantity of said burst information; and
means for creating at least one category into which said burst information is placed.

21. The medium of claim 15, wherein said at least one category represents a portion of a committed information rate (CIR).
